(19) United States
(12) Patent Application Publication
(10) Pub. No.: US 2015/0303538 A1
(43) Pub. Date: Oct. 22, 2015

(54) COMPACT BATTERY WITH HIGH ENERGY DENSITY AND POWER DENSITY

(71) Applicant: CYNTEC CO., LTD., Hsinchu (TW)

(72) Inventors: Chin-Ming CHEN, Hsinchu (TW); Zhong-Hau YANG, Hsinchu (TW); Yi-Chun CHEN, Hsinchu (TW); Hung-Chieh TSAI, Hsinchu (TW); Hui-Ling WEN, Hsinchu (TW)

(21) Appl. No.: 14/687,510

(22) Filed: Apr. 15, 2015

Related U.S. Application Data
(60) Provisional application No. 61/980,584, filed on Apr. 17, 2014.

(51) Int. Cl. H01M 12/00; H01M 2/16

(52) U.S. Cl. CPC H01M 12/00; H01M 2/1653; H01M 2220/30

(57) ABSTRACT

A battery device includes a battery housing and a plurality of units disposed in the battery housing. The units include different electrolytes and conduct at least two different reactions for supplying electricity to an external device. Preferably, the plurality of units includes a first unit and a second unit, wherein the first unit has a higher energy density than the second unit, and the second unit has a higher power density than the first unit.

### CROSS-REFERENCE TO RELATED APPLICATIONS

The present application is a nonprovisional application claiming benefit from a prior-filed provisional application bearing a Ser. No. 61/980,584 and filed Apr. 17, 2014, contents of which are incorporated herein for reference.

### FIELD OF THE INVENTION

The present invention relates to a battery, and more particularly to a battery which is compact in size while exhibiting high energy density as well as high power density.

### BACKGROUND OF THE INVENTION

With the dramatic development of multi-functional portable consumer electronics, e.g. smart phones, tablets, wearable devices, etc., the performance of batteries and compactness of the devices are keys to commercial success. While reduction in device size is desirable, it is also necessary to support long-term use and high peak-power for internet access. Therefore, batteries exhibiting both high energy density and high power density are required. Unfortunately, conventional lithium-ion batteries, when applied to devices involving high instantaneous power, do not exhibit satisfactory power density, so the standby time of a device using such a battery is generally not long enough, and peak power is likely to shut down the device. The problem is even serious for multi-core computer or communication systems. Furthermore, the lower the temperature, the more serious the shut-down problem.

In spite a supercapacitor may be coupled to a lithium ion battery to prevent from peak power damage, the physical attachment or electric connection of a supercapacitor device to a lithium ion battery device described in prior art, e.g. U.S. Pat. No. 5,587,250, WO 2007/097534, U.S. Pat. No. 5,821,006, would adversely affect the compactness and cost of the battery since additional components and complicated manufacturing process are required.

### SUMMARY OF THE INVENTION

Therefore, the present invention provides a battery which is compact in size while exhibiting high energy density as well as high power density.

The present invention provides a battery device, which comprises a battery housing; a spacer disposed in the battery housing for dividing the space in the battery housing into at least first and second rooms for respectively accommodating therein at least first and second units with different electrolytes, wherein the spacer is made of an insulating and electrochemically inert material, and is capable of fusing with a material of the battery housing; a positive common terminal electrically connected to positive electrodes of at least the first and second units; and a negative common terminal electrically connected to negative electrodes of at least the first and second units. The first unit and the second unit include different electrolytes and perform different electrochemical reactions.

According to another aspect of the present invention, a method for producing the battery device is provided, which comprises: providing a first housing sheet and a second housing sheet for forming the battery housing, and a spacer sheet for forming the spacer; aligning the first housing sheet, the spacer sheet and the second housing sheet in order; sealing the aligned first housing sheet, the spacer sheet and the second housing sheet to form the first room between the first housing sheet and the spacer sheet, and the second room between the spacer sheet and the second housing sheet, wherein the first and second rooms have respective injection openings for electrolyte injection; installing the first unit and the second unit into the first room and the second room, respectively, including the electrolyte injection into the first and second rooms via the first and second injection openings; and sealing the injection openings after completing the electrolyte injection.

According to a further aspect of the present invention, a method for producing the battery device is provided, which comprises: providing a unit housing, inside which is the second room; installing the unit housing into the battery housing, thereby providing the first room between an outer wall of the unit housing and an inner wall of the battery housing, wherein the first room has a first injection opening for first electrolyte injection for installing the first unit into the first room; and sealing the first injection opening after completing the first electrolyte injection.

The plurality of units according to the present invention may conduct at least a faradaic reaction and a non-faradaic reaction, e.g. electric double layer reaction, so as to exhibit different and complementary properties. The battery device according to the present invention can be used with a portable device such as a smart phone, a tablet, a wearable device or the like due to the compact feature.

### BRIEF DESCRIPTION OF THE DRAWINGS

The above contents of the present invention will become more readily apparent to those ordinarily skilled in the art after reviewing the following detailed description and accompanying drawings, in which:

FIGS. 1A and 1B are schematic cross-sectional and cutaway perspective views illustrating a first embodiment of a battery device according to the present invention;

FIGS. 2A and 2B are schemes illustrating a process for producing the first embodiment of battery device;

FIG. 3A is a schematic cross-sectional view illustrating a second embodiment of a battery device according to the present invention;

FIG. 3B is a schematic diagram illustrating an exemplified structure of one cell according to the present invention;

FIG. 4 is a schematic cross-sectional view illustrating a third embodiment of a battery device according to the present invention;

FIG. 5 is a schematic cross-sectional view illustrating a fourth embodiment of a battery device according to the present invention; and

FIG. 6 is a schematic cutaway perspective view illustrating an exemplified interconnection of units of a battery device according to the present invention;

FIG. 7A is a plot schematically illustrating the property of a supercapacitor unit according to the present invention; and

FIG. 7B is a plot schematically illustrating the property of a battery unit according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

Hereinafter, embodiments of batteries which exhibit high energy density as well as high power density and have shapes and sizes fitting commercialized portable consumer electronics are illustrated with reference to associated drawings.

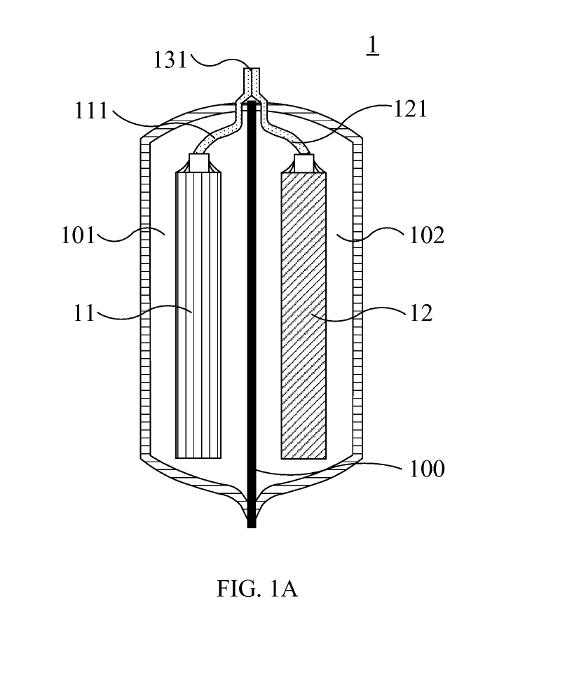

Please refer to FIGS. 1A and 1B, which schematically illustrates a first embodiment of a battery device according to the present invention. FIG. 1A is a schematic cross-sectional view of the battery device. FIG. 1B is a schematic cutaway perspective view of the battery device. The battery device 1 includes a battery housing 10 and a spacer 100 disposed inside the battery housing 10 for dividing the space in the battery housing 10 into a first room 101 and a second room 102. The battery device further includes a first unit 11 and a second unit 12 to be installed in the first room 101 and the second room 102, respectively. The first unit 11 and the second unit 12 include different electrolytes and conduct different reactions inside respective rooms. By electrically connecting the first unit 11 and the second unit 12 to a common positive terminal 131 via respective positive electrodes 111 and 121 and to a common negative terminal 132 via respective negative electrodes 112 and 122, for example in parallel, the different reactions work together to provide different and complementary properties for the battery device. For example, the first unit 11 may be, but not limited to, a lithium ion cell conducting a faradaic reaction and the second unit 12 may be, but not limited to, a supercapacitor conducting an electric double layer reaction.

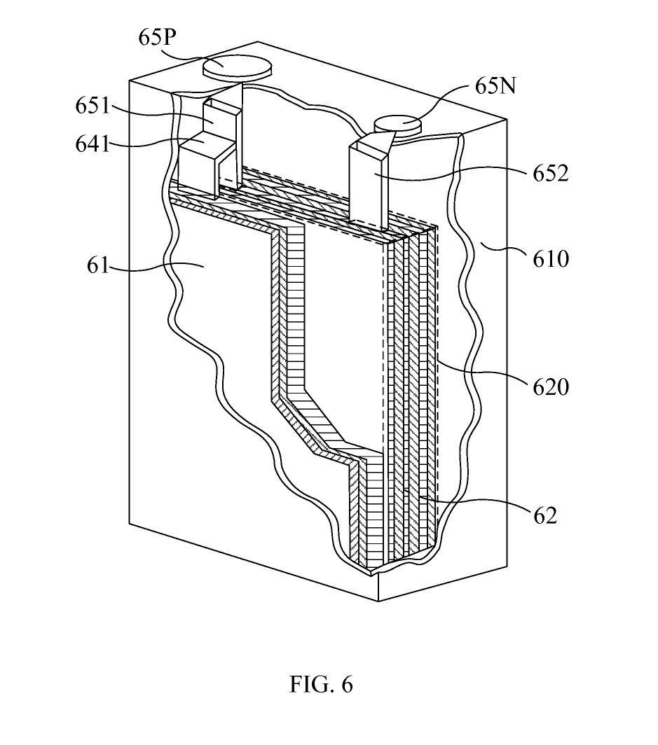

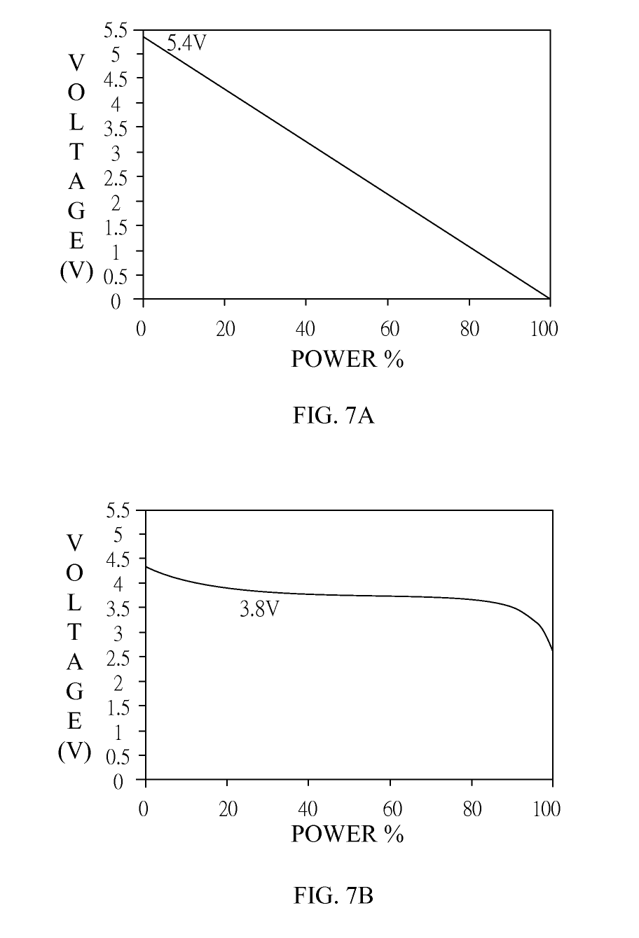

The term “electric double layer” used herein indicates two layers distributed at the interface between a solid material and a liquid material and substantially including positive and negative ions, respectively. As the surface of the solid material attracts positive (or negative) ions in the solution so as to be positively (or negatively) charged, the charges in the solution are redistributed based on the Coulomb's law so that the level of negative (or positive) ions increases in the liquid material at the interface with the solid material, thereby forming the electric double layer. A capacitor having a level of capacitance higher than about millifarad can generally be defined as a supercapacitor. The energy storage properties of a supercapacitor and a lithium ion cell are different and respectively shown in FIGS. 7A and 7B. As shown in FIG. 7A, a supercapacitor is a high power system, in which capacitance linearly correlates to voltage. On the other hand, as shown in FIG. 7B, a lithium ion (or lithium polymer) cell is a high energy system exhibiting steady discharging for providing long-term electricity to the device. Accordingly, as known to those skilled in the art, the lithium ion cell having a high energy density (high energy capacity per size) and the supercapacitor having a high power density (high current) can work together to basically supply electricity to an external device, while buffering peak power occurring during the use of the external device. Depending on desired properties such as backup power, instantaneous peak power tolerance and timely storage upon data transmission, selected units can be used and combined based on the teaching of the present invention. Table 1 compares general levels of energy density and power density of a battery and a supercapacitor. The terms “high energy density” and “high power density” mean the energy density and power density are above averages, approaches the upper limits, or even better.

TABLE 1

| | Supercapacitor | Battery |
|---|---|---|
| Energy density | 1~10 | 10~100 |
| (Wh/kg) | | |
| Power density | 100~5,000 | 50~130 |
| (W/kg) | | |

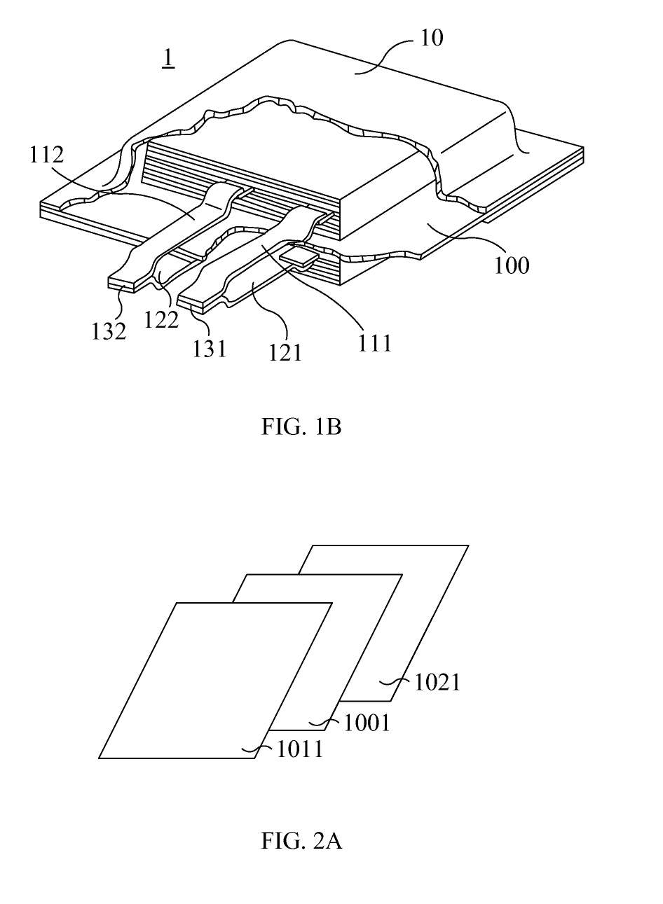

FIGS. 2A and 2B schematically illustrate an exemplified process for producing the battery device 1. First of all, a first housing sheet 1011 and a second housing sheet 1021 for forming the battery housing 10, and a spacer sheet 1001 for forming the spacer 100 are provided. The first housing sheet 1011, the spacer sheet 1001 and the second housing sheet 1021 are aligned in order, as shown in FIG. 2A. The aligned first housing sheet 1011, the spacer sheet 1001 and the second housing sheet 1021 are then sealed, for example by heat-sealing or laser sealing, to form the first room 101 between the first housing sheet 1011 and the spacer sheet 1001, and the second room 102 between the spacer sheet 1001 and the second housing sheet 1021. The spacer sheet should be non-conductive, electrochemically inert, and capable of fusing with the material of the housing sheet, e.g. metal-polymer composite film or polymer. A first injection opening 1012 and a second injection opening 1022 are reserved from the sealing operation, as shown in the top view of FIG. 2B. Afterwards, the first unit 11 and the second unit 12 are installed into the first room 101 and the second room 102 from the first injection opening 1012 and the second injection opening 1022, respectively.

In the above-described embodiment, the first and second units 11 and 12 are put into the first room 101 and the second room 102, respectively, and the electrolytes adapted to be used in the first and second units 11 and 12 are injected into the rooms 101 and 102 from the first and second injection openings 1012 and 1022 after the sealing procedure. Alternatively, the first and second units 11 and 12 may be aligned with the first housing sheet 1011, the spacer sheet 1001 and the second housing sheet 1021 in advance, so that the installation of the units 11 and 12 in the first and second rooms 101 and 102 can be conducted along with the sealing procedure. Then the electrolytes of the first and second units 11 and 12 are injected into respective rooms 101 and 102 after the sealing procedure. In this alternative embodiment, four sides of the sheets interleaved with the units can be sealed and only small injection openings are left for electrolyte injection. The injection openings can be left on a top face or a side face, depending on practical requirements.

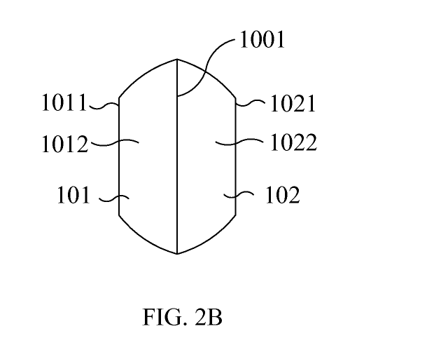

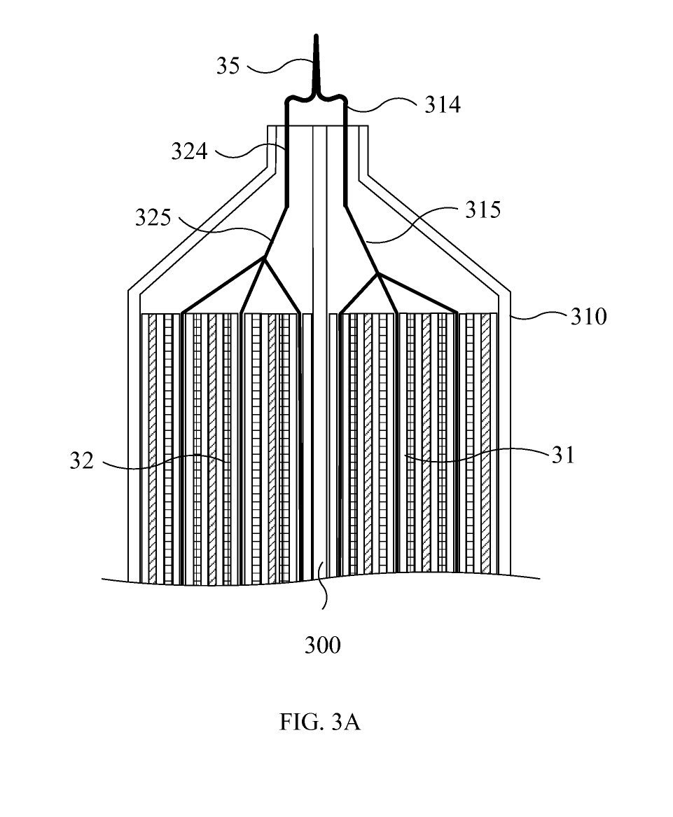

Optionally, the first unit 11 and the second unit 12 may respectively include more than one cell for further enhancement or additional functions. The cells in each unit can be electrically connected in series or in parallel. FIG. 3A schematically illustrates a battery device according to another embodiment of the present invention, which includes three cells electrically connected to each other in parallel in each of the first and second units 31 and 32. The first and second units 31 and 32 are then electrically connected to each other in parallel. In an example, the first unit 31 is a supercapacitor unit including three supercapacitor cells and the second unit 32 is a battery unit including three battery cells. Each cell, for example, includes a positive electrode, a separator and a negative electrode, as shown in FIG. 3B. In this example, the positive electrode of each supercapacitor cell is composed of a metal layer 321, e.g. aluminum, sandwiched by two reaction layers 3210, e.g. activated carbon, and the negative electrode of each supercapacitor cell is composed of a metal layer 323, e.g. aluminum, sandwiched by two reaction layers 3230, e.g. activated carbon. On the other hand, the positive electrode of each battery cell is composed of a metal layer 321, e.g. aluminum, sandwiched by two reaction layers 3210, e.g. lithium metal oxide; and the negative electrode of each battery cell is composed of a metal layer 323, e.g. copper, sandwiched by two reaction layers 3230, e.g. graphite. Since the electrolyte needs to exist among the electrodes and the cells, the separators 322 disposed between electrodes and cells are made of insulating porous material which is inert to the electrolyte. In contrast, the spacer 300 disposed between the first and second units 31 and 32 should be made a material, which is not only insulating and inert to both the electrolytes of the units, but also electrolyte-impermeable.

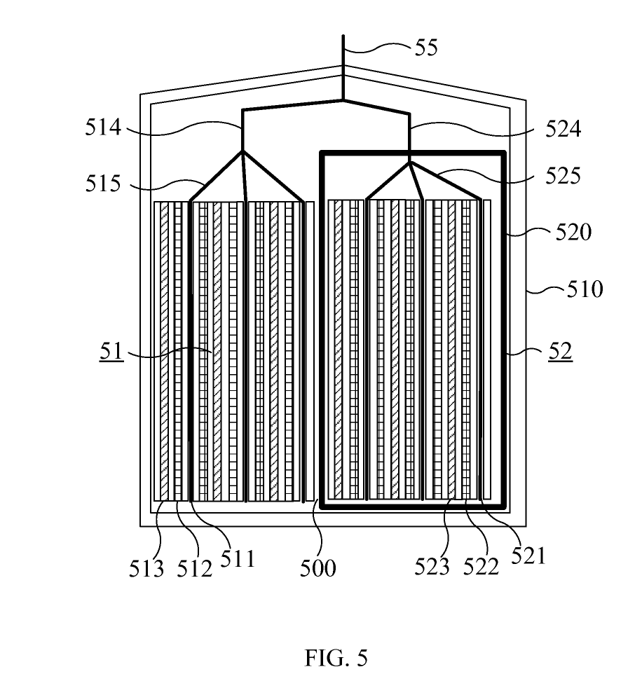

Please refer to FIG. 3A again. Please be noted that FIG. 3A is a cross-sectional view so that only one partial connection of electrodes is shown, and applicable to the portion not shown. The supercapacitor cells of the supercapacitor unit 31 are interconnected in parallel by electrically connecting their positive electrodes to a positive terminal 314 via a positive electrode tab 315 while electrically connecting their negative electrodes to a negative terminal via a negative electrode tab (not shown). Likewise, the battery cells of the battery unit 32 are interconnected in parallel by electrically connecting their positive electrodes to a positive terminal 324 via a positive electrode tab 325 while electrically connecting their negative electrodes to a negative terminal via a negative electrode tab (not shown). The positive terminal 314 of supercapacitor unit 31 and the positive terminal 324 of battery unit 32 are further coupled to a positive common terminal 35. For example but not for limitation, the positive electrode tabs 315 and 325 are hidden from the battery housing 310, and the positive terminals 314 and 324 are partially exposed from the battery housing 310 to be electrically connected to the positive external terminal 35. Alternatively, the positive common terminal 35 and the negative common terminal (not shown) may be the only electrode part uncovered by the battery housing 310 (like the configuration as shown in FIG. 6, which will be described later) so as to be neat in appearance. Furthermore, it would be advantageous that the battery device looks like a commercially available common battery while exhibiting both high energy density and high power density. Since two rooms for respectively accommodating the supercapacitor unit 31 and the battery unit 32 can be simultaneously formed in a single sealing process with two housing sheets and one spacer sheet, this embodiment is advantageous in sharing the manufacturing device and simplifying the manufacturing process.

It is to be noted that although the cells in the supercapacitor unit 31 and the battery unit 32 are exemplified to be interconnected in parallel. They may also be interconnected in series for different objectives, e.g. in considerations of supplied voltages, withstand voltages, capacities etc.

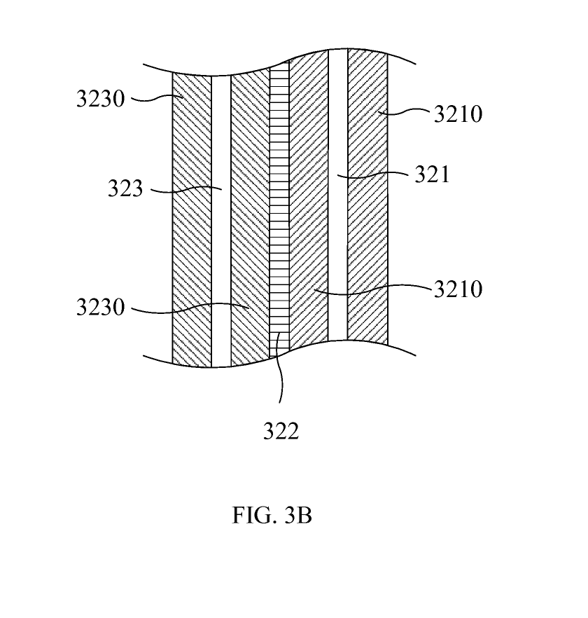

FIG. 4 schematically illustrates another embodiment of a battery device according to the present invention. The battery device 4 includes a battery housing 410 and a unit housing 420. The unit housing 420 is disposed inside the battery housing 410. A space between the outer wall of the unit housing 420 and the inner wall of the battery housing 410 is defined as a first room 401, and the space inside the unit housing 420 is defined as a second room 402. The first room 401 and the second room 402 are provided for installing therein a first unit 41 and a second unit 42, respectively. The first unit 41 and the second unit 42 include different electrolytes and conduct different reactions inside respective rooms. By electrically connecting the first unit 41 and the second unit 42, for example in parallel, the different reactions work together to provide different and complementary properties for the battery device. For example, the first unit 41 may be, but not limited to, a lithium ion cell conducting a faradaic reaction and the second unit 42 may be, but not limited to, a supercapacitor cell conducting an electric double layer reaction. Accordingly, the lithium ion cell having a high energy density and the supercapacitor cell having a high power energy can work together to basically supply electricity to an external device, while buffering peak power occurring during the use of the external device. Depending on desired properties such as backup power, memory protection and/or peak power tolerance, selected units can be used and combined based on the teaching of the present invention.

For producing the battery device 4, an electrode set of the second unit 42 is put inside the unit housing 420, a corresponding electrolyte thereof is injected into the second room 402, and then seal the unit housing 420. The unit housing 420 with the second unit 42 installed therein is then installed into the battery housing 410, which has been installed therein the electrode set of the first unit 41. Afterwards, a corresponding electrolyte 400 is injected into the first room 401 via an injection opening (not shown) disposed on a top face or a side face of the battery housing 410 depending on practical requirements. After completing the electrolyte injection, the injection opening is sealed, and the second unit 42 is electrically connected to common electrode terminals 45 along with the first unit 41 via electrode terminal 441 thereby completing the process for producing the battery device 4.

In this embodiment, the unit housing 420 is placed into the battery housing 410 after the installation of the second unit 42 is accomplished. Alternatively, it is also feasible to install the electrode set into the second room 402 only without injecting the electrolyte at this stage. Instead, an injection opening (not shown) is previously provided on the unit housing 420. After the unit housing 420 containing the electrode set is installed into the battery housing 410, respective electrolyte injections into respective rooms through respective openings can be performed simultaneously or in sequence in the battery housing 410.

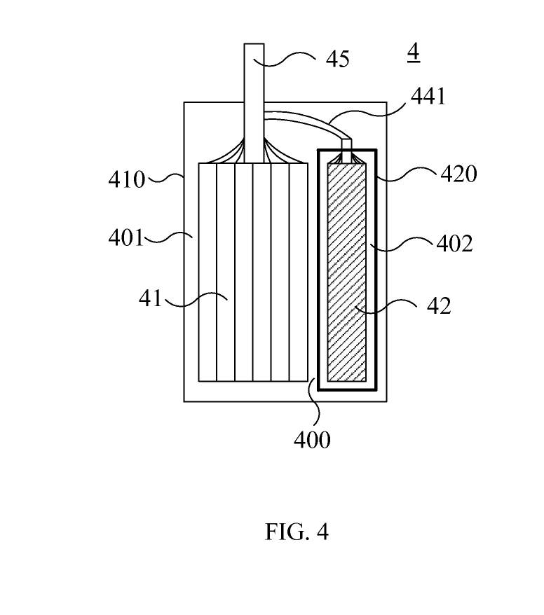

Similar to the embodiment illustrated in FIG. 3A, the battery device with a unit housing inside a battery housing may also include multiple battery cells and multiple supercapacitor cells, as illustrated in FIG. 5. Please be noted that FIG. 5 is a cross-sectional view so that only one partial connection of electrodes is shown, and applicable to the portion not shown. In this embodiment, the battery unit 52 has its own unit housing 520 and a wall of the unit housing 520 serves as the spacer 500 for isolating the battery unit 52 from the supercapacitor unit 51. The supercapacitor cells of the supercapacitor unit 51 are interconnected in parallel by electrically connecting their positive electrodes 511 to a positive terminal 514 via a positive electrode tab 515 while electrically connecting their negative electrodes 513 to a negative terminal via a negative electrode tab (not shown). Likewise, the battery cells of the battery unit 52 are interconnected in parallel by electrically connecting their positive electrodes 521 to a positive terminal 524 via a positive electrode tab 525 while electrically connecting their negative electrodes 523 to a negative terminal via a negative electrode tab (not shown). In each supercapacitor cell, a separator 512 is disposed between the positive electrode 511 and the negative electrode 513. Likewise, in each battery cell, a separator 522 is disposed between the positive electrode 521 and the negative electrode 523. The positive terminals 514 of supercapacitor unit 51 and the positive terminal 524 of battery unit 52 are further coupled to a positive common terminal 55. For example but not for limitation, the positive electrode tabs 515 and 525 are hidden from the battery housing 510, and the positive terminals 514 and 524 are partially exposed from the battery housing 510 to be electrically connected to the positive external terminal 55. Alternatively, the positive common terminal 55 and the negative common terminal (not shown) may be the only electrode part uncovered by the battery housing 510 (like the configuration as shown in FIG. 6, which will be described later) so as to be neat in appearance. Furthermore, it would be advantageous that the battery device looks like a commercially available common battery while exhibiting both high energy density and high power density.

It is to be noted that although the cells in the supercapacitor unit 51 and the battery unit 52 are exemplified to be interconnected in parallel. They may also be interconnected in series for different objective, e.g. in considerations of supplied voltages, withstand voltages, capacities etc.

Please refer to FIG. 6, which schematically exemplifies the electrical connection of a first unit 61 to a second unit 62. In this example, the second unit 62 has its own unit housing 620 placed inside the battery housing 610 and serving as a spacer. Preferably, the unit housing 620 is a flexible pack while the battery housing 610 is a rigid case. The electrode terminal 651, e.g. a positive electrode terminal, extends from the second unit 62 and electrically connected to an exposed common terminal 65P. The electrode tab 641 of the first unit 61 is coupled to the electrode terminal 651 so as to be electrically connected to the exposed common terminal 65P as well. In this example, the electrode terminal 651 and the electrode tab 641 are both hidden from the battery housing 610. Similar discussion can be applied to the negative electrode portion with the negative electrode terminal 652, although partially omitted in this figure, and is not to be redundantly described herein. Therefore, only the positive common terminal 65P and the negative common terminal 65N are exposed.

In the above-described embodiments and associated modifications and variations, the material of the battery housing, for example, can be metal-polymer composite film, aluminum or stainless, and the material of the spacer or the unit housing, for example, can be polymeric films or composite material layers. The polymeric films, for example, can be made of polyethylene (PE), poly propylene (PP), Nylon, Polyethylene terephthalate (PET), Polyimide (PI), Polyphthalamide (PPA), and any other suitable polymer film having high isolation capability. The material of the positive electrode of the battery unit, for example, can be lithium-based metal oxides, including LiCoO₂, LiMn₂O₄, LiFePO₄, LiNiₓCo_{y}Mn_{z}O₂ or any other suitable lithium-based metal oxide or complex. The material of the negative electrode of the battery unit, for example, can be graphite, silicon, lithium titanium oxide or complex. The material of the positive electrode of the supercapacitor unit, for example, can be metal oxides, including RuO₂, Ni(OH)₂, MnO₂ or any other suitable metal oxide, or carbon-based materials, including activated carbon, graphene, carbon nanotube or any other suitable carbon-based material. The material of the negative electrode of the supercapacitor unit, for example, can be carbon-based material, including activated carbon, graphene, carbon nanotube or any other suitable carbon-based material.

The term “electrolyte” used herein can be constituted by a compound or a composition, and it can be in any other suitable form such as solution, gel or solid.

The battery device according to the present invention can be used with a portable device such as a smart phone, a tablet, a wearable device or the like due to the compact feature.

According to the present invention, the footprint of a cell electrode conducting a non-Faradaic reaction can be magnified to a level similar to a cell electrode conducting a Faradaic reaction. Accordingly, the parallel connecting number of the non-Faradaic cell electrodes can be reduced so as to lower internal resistance. Meanwhile, the area of the non-Faradaic cell electrodes can be effectively used within limited space. Since no additional space is required, the cost of packaging material can be saved, and the manufacturing process can be simplified. For a portable 3C product which is required to be light and thin, it has to be equipped with a reduced thickness of lithium-ion battery, which is generally accompanied by lowered battery capacity and deteriorated discharging capacity at high C-rate. The term “C-rate” means the charging/discharging rate of a battery and can be expressed as a ratio of charging or discharging current intensity to battery capacity. For example, for a 50 Ah battery to be charged under a charging current intensity 10 A, it will take 5 hours to fully charge the battery. Accordingly, the C-rate is 10/50=0.2C. In another example, for a 50 Ah battery to be charged under a charging current intensity 50 A, it will take 1 hour to fully charge the battery. Accordingly, the C-rate is 50/50=1C. In a further example, for a 50 Ah battery to be charged under a charging current intensity 100 A, it will take 0.5 hours to fully charge the battery. Accordingly, the C-rate is 100/50=2C. Depending on different applications, the level of high C-rate has different definitions. Giving a mobile phone as an example, the level 2C can be considered as high C-rate. By combining a lithium ion cell with a supercapacitor according to the present invention without changing the thickness of the final product, the properties of low impedance and discharging with instantaneously high current of the supercapacitor can be made use of to compensate the deficiency of the lithium ion cell, particularly at a relatively low temperature. In addition, the lifespan of the lithium ion cell can be prolonged. To sum up, the present battery device makes use of the space of the common battery housing to improve the high-current discharging performance without increasing packaging material and efforts. Moreover, the configuration of the battery device having a unit pack directly placed into the battery housing is advantageous in the flexibility of the manufacturing process.

While the invention has been described in terms of what is presently considered to be the most practical and preferred embodiments, it is to be understood that the invention needs not to be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A battery device, comprising:
a battery housing;
a spacer disposed in the battery housing for dividing the space in the battery housing into at least first and second rooms for respectively accommodating therein at least first and second units with different electrolytes, wherein the spacer is made of an insulating and electrochemically inert material, and is capable of fusing with a material of the battery housing;
a positive common terminal electrically connected to positive electrodes of at least the first and second units; and
a negative common terminal electrically connected to negative electrodes of at least the first and second units;
wherein the first unit and the second unit include different electrolytes and perform different electrochemical reactions.

2. The battery device according to claim 1 wherein the first unit has a higher energy density than the second unit, and the second unit has a higher power density than the first unit.

3. The battery device according to claim 1 wherein one of the first and second units conducts a faradaic reaction and the other of the first and second units conducts an electric double layer reaction, so as to exhibit different and complementary properties.

4. The battery device according to claim 1 wherein the positive common terminal and the negative common terminal are uncovered from the battery housing.

5. The battery device according to claim 1, wherein the spacer is made of a polymeric film or a composite material.

6. The battery device according to claim 5, wherein the spacer is made of a material selected from a group consisting of polyethylene (PE), poly propylene (PP), Nylon, Polyethylene terephthalate (PET), Polyimide (PI) and Polyphthalamide (PPA).

7. The battery device according to claim 1 wherein the second room is disposed inside the first room.

8. The battery device according to claim 1 wherein the first unit includes a plurality of cells electrically interconnected in parallel.

9. The battery device according to claim 1 wherein the second unit includes a plurality of cells electrically interconnected in parallel.

10. The battery device according to claim 1 wherein the first unit and the second unit are electrically connected to each other in parallel.

11. A method for producing the battery device according to claim 1, comprising:
providing a first housing sheet and a second housing sheet for forming the battery housing, and a spacer sheet for forming the spacer;
aligning the first housing sheet, the spacer sheet and the second housing sheet in order;
sealing the aligned first housing sheet, the spacer sheet and the second housing sheet to form the first room between the first housing sheet and the spacer sheet, and the second room between the spacer sheet and the second housing sheet, wherein the first and second rooms have respective injection openings for electrolyte injection;
installing the first unit and the second unit into the first room and the second room, respectively, including the electrolyte injection into the first and second rooms via the first and second injection openings; and
sealing the injection openings after completing the electrolyte injection.

12. The method according to claim 11 wherein the first housing sheet and the second housing sheet are metal-polymer composite films and the spacer sheet is a polymeric film.

13. A method for producing the battery device according to claim 7, comprising:
providing a unit housing, inside which is the second room;
installing the unit housing into the battery housing, thereby providing the first room between an outer wall of the unit housing and an inner wall of the battery housing, wherein the first room has a first injection opening for first electrolyte injection for installing the first unit into the first room; and
sealing the first injection opening after completing the first electrolyte injection.

14. The method according to claim 13 wherein second electrolyte injection for installing the second unit into the second room is performed before the unit housing is installed into the battery housing.

15. The method according to claim 13 wherein second electrolyte injection for installing the second unit into the second room is performed after the unit housing is installed into the battery housing.

16. The method according to claim 13 wherein the first electrolyte injection is performed after the unit housing is installed into the battery housing.

17. The method according to claim 16 wherein the first unit includes an electrode set, which is installed into the battery housing before the unit housing is installed into the battery housing.
